(19) United States
(12) Patent Application Publication
(10) Pub. No.: US 2007/0268895 A1
(43) Pub. Date: Nov. 22, 2007

(54) METHOD AND APPARATUS FOR SWITCHING DATA

(75) Inventors: Gerald T. Foster, Swindon (GB); Bohdan L. Bodnar, Park Ridge, IL (US); Stephen J. Wesoloski, Palatine, IL (US); Gary E. Western, Johnsburg, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/419,216

(22) Filed: May 19, 2006

(51) Int. Cl. H04L 12/56

(52) U.S. Cl. 370/389

(57) ABSTRACT

An apparatus is provided for switching data between input and output lines. The input and output lines are coupled to a number of line termination boards which are interconnected by a network. The line termination boards comprise a data block processor which for each switch interval combines data from the input connections (such as time slots) associated with output lines of another line termination board and an interface for transmitting the combined data to these over the network. A mapping processor generates mapping data that maps data of the combined data to the output connections. The mapping data is transmitted to the receiving line termination board which comprises a de-mapping processor which allocates data of the combined data to the appropriate output connections in response to the mapping data.

### FIELD OF THE INVENTION

The invention relates to a method and apparatus for switching data and in particular, but not exclusively, to switching of data in telecommunication networks such as cellular communication systems.

### BACKGROUND OF THE INVENTION

Telecommunication systems, such as mobile cellular telecommunication systems or traditional landline systems, include functionality for communicating data between subscriber units. In order to allow any subscriber unit to be connected to any other subscriber unit or to an external network, the telecommunication systems often comprise complex and centralised switches that can dynamically switch data between a large number of input and output connections. Such switches tend to be very large, costly and complex.

For example, in a Global System for Mobile (GSM) cellular communication system, a large number of Base Station Controllers (BSCs) are coupled to a centralised switch which is capable of switching data dynamically between the different BSCs. The BSCs are typically coupled to the switch via E1 communication links and the data from/to the individual mobile stations are communicated in time slots of the E1 link.

Traditionally, such switches are arranged as Time Space Time (TST) switches wherein a few time slots are switched at a time. For example, for each E1 line, five time slots (each corresponding to a time interval that is a fraction of the samples, i.e. 125 μsec/five for E1 TDM) are stored in a short input buffer. The input buffers are coupled to a physical switch matrix which in each time slot interval can switch each of the input buffers to any of the output buffers thereby providing the switching of data from one time slot on an input E1 line to any desired time slot on an output E1 line.

However, such a switch approach has a number of associated disadvantages:
The switch is very complex and costly. Especially, the implementation of a large physical switch matrix is difficult and costly and reduces flexibility.
It is inherently difficult to scale the switching functionality. For example, increasing the switching size for more input/output lines or connections requires additional hardware.
It is difficult to create a 1:N fan-out where an input time slot/connection is switched to a plurality of output time slots/connections. Specific external and additional functionality is required to achieve this.
Synchronization is required.
Variable rate switching is difficult. Specifically, it is difficult to efficiently switch data with a lower granularity than the nominal granularity/data rate for which the switching functionality has been designed.
Specialized hardware is required, which further increases cost.
It is inherently difficult to multiplex sub-rate traffic onto a common destination link.
All traffic flows require explicit elastic stores (buffers).
Separate control and data paths are implemented. This increases space usage.
In the event that all data paths are not used, it is impossible to statistically multiplex paths.
It does not provide any differentiation between real-time and non-real-time data traffic.

Hence, an improved system for switching data in a communication system would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for switching data between input and output lines, the apparatus comprising: a plurality of input means each having at least one input line supporting a plurality of input connections; a plurality of output means each having at least one output line supporting a plurality of output connections; a network connecting the plurality of input means with the plurality of output means; wherein at least a first input means comprises: means for, for each switch interval, combining data of the input connections for a first output means into a data block, and means for, for each switch interval, transmitting the data block to the first output means over the network; and the apparatus further comprises: mapping means for generating mapping data that maps data of the data block to output connections of at least one output line of the first output means; and means for transmitting the mapping data to the first output means; and wherein the first output means comprises allocation means for allocating data of the data block to the output connections in response to the mapping data.

The invention allows improved switching of data. A reduced cost and/or complexity can be achieved. A flexible switching allowing switching of different data rates can be achieved. The invention allows the use of low cost and/or general purpose hardware. Specifically, the invention may obviate or eliminate the need for implementation of a large physical switch matrix.

The data block may be communicated in one or more data messages of the network.

According to an optional feature of the invention, the input connections correspond to time slots of the at least one input line and the output connections correspond to time slots of the at least one output line.

This allows compatibility with and/or improves performance for communication systems using time division multiplexing techniques. For example, the invention can allow improved performance in cellular communication systems such as GSM.

The described architecture may be particularly suited and provide particularly advantageous performance for timeslot data switching.

According to an optional feature of the invention, the data block comprises no signalling overhead data.

This can allow improved operation and in particular allow reduced complexity and reduced communication resource requirement of the network. The data block can be transmitted in messages which comprise overhead data relating to the network transmission but not the switching behaviour.

According to an optional feature of the invention, the mapping data associates user data of time slots of the input lines with time slots of the output lines.

This allows particularly advantageous performance and in particular allows a highly efficient yet low complexity switching in time multiplexed systems.

According to an optional feature of the invention, the network is an Ethernet network.

This reduces complexity and can reduce cost. In particular, the use of an Ethernet interconnecting network can allow standard hardware and software to be used to a wide degree.

According to an optional feature of the invention, the at least one input line is an E1 line.

This reduces complexity and can reduce cost. In particular, the use of an E1 line allows standard hardware and software to be used to a wide degree. Furthermore, this feature allows improved compatibility with a number of existing systems, such as the GSM cellular communication system.

In some embodiments, at least one output line comprises an E1 line.

According to an optional feature of the invention, the mapping data includes a data rate indication for data of an input connection.

This allows improved performance and flexibility. In particular, it allows a low complexity and cost efficient way of achieving efficient switching of different data rates. The allocation means may be arranged to allocate data in response to the data rate indication.

According to an optional feature of the invention, the mapping means is arranged to update the mapping data with a different time interval than the switch interval.

This can allow improved flexibility and reduced operational and/or hardware complexity. In particular, the mapping data can be updated with a longer time interval than the switch interval.

According to an optional feature of the invention, the mapping means is arranged to determine the mapping data in response to a signalled connection request.

This allows an efficient approach to managing and modifying the switching behaviour of the switch and in particular allows a low complexity approach to changing the switching between input and output connections so as to implement the required switching.

According to an optional feature of the invention, the mapping data associates positions of data in the data block to output connections.

This allows an efficient yet low complexity and flexible switching of data. The allocation means can allocate data in response to the positions of the data in the block and the mapping data. The position can be an absolute or relative position, such as a sequential arrangement of data from different connections.

According to an optional feature of the invention, the allocation means is arranged to allocate data of the data block to output connections of a plurality of output lines.

This allows efficient and/or low complexity switching.

According to an optional feature of the invention, the mapping data comprises a mapping of a data block of an input connection to a plurality of output connections.

This allows efficient and/or low complexity switching. Specifically, it can allow a fan out of 1:N (N>1) such that the data of an input connection is distributed to more than one output connection. For example the data of an incoming time slot from a subscriber unit can, in parallel, be fed to a plurality of output time slots, possibly on different output lines.

According to an optional feature of the invention, a number of input connections per switch interval exceed ten input connections per input means.

This allows efficient, flexible and/or low complexity switching to be achieved.

According to an optional feature of the invention, the means for combining data of the input connections is arranged not to include data in the data block for input connections not comprising data.

This allows an improved switching performance and in particular can allow reduced communication and burden on the network and reduced operational complexity of the output means.

According to an optional feature of the invention, the mapping means comprises: means for receiving connection information associating input connections and output connections; and means for determining the mapping data in response to the connection information.

This allows improved switching and/or reduced complexity.

According to an optional feature of the invention, the mapping data relates to a plurality of input lines.

This allows improved switching and/or reduced complexity.

According to an optional feature of the invention, the mapping data relates to a plurality of output lines.

This allows improved switching and/or reduced complexity.

According to another aspect of the invention, there is provided a cellular communication system comprising an apparatus as described above. The cellular communication system may for example be a GSM cellular communication system.

According to another aspect of the invention, there is provided a method of switching data between input and output lines in an apparatus including a plurality of input means each having at least one input line supporting a plurality of input connections; a plurality of output means each having at least one output line supporting a plurality of output connections and a network connecting the plurality of input means with the plurality of output means; the method comprising: at a first input means performing the steps of: in each switch interval, combining data of the input connections for a first output means into a data block; and in each switch interval, transmitting the data block to the first output means over the network; and further performing the steps of: generating mapping data that maps data of the data block to output connections of at least one output line of the first output means; and transmitting the mapping data to the first output means; and at the output means allocating data of the data block to the output connections in response to the mapping data.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a cellular communication system in accordance with the prior art;

FIG. 2 illustrates an example of a switch in accordance with some embodiments of the invention;

FIG. 3 illustrates elements of a line termination board in accordance with some embodiments of the invention; and

FIG. 4 illustrates elements of a line termination board in accordance with some embodiments of the invention.

### DETAILED DESCRIPTION OF SOME EMBODIMENTS OF THE INVENTION

The following description focuses on embodiments of the invention applicable to a GSM cellular communication system. However, it will be appreciated that the invention is not limited to this application but may be applied to many other networks or communication systems wherein switching of data between input and output connections is performed.

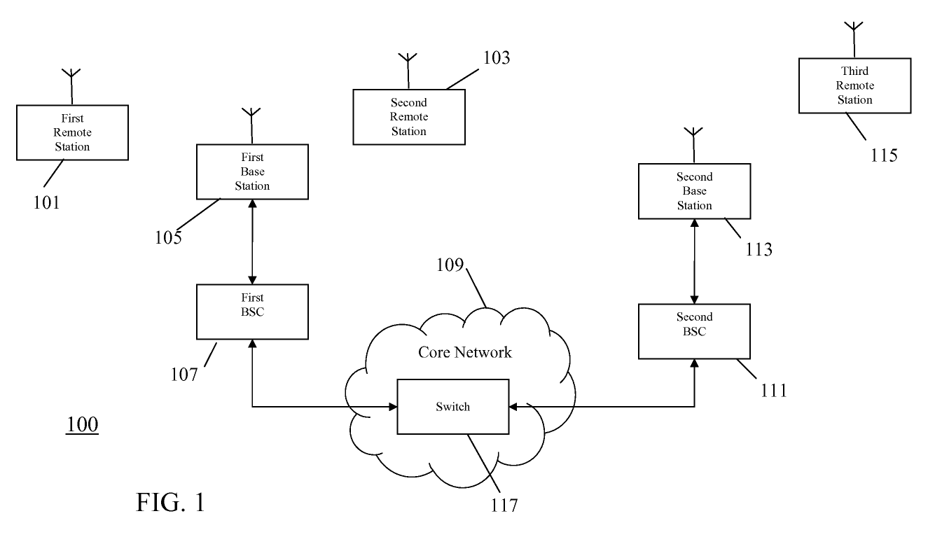

FIG. 1 illustrates an example of a cellular communication system 100 in which embodiments of the invention may be employed. Specifically, the cellular communication system is a GSM cellular communication system.

Further description of the GSM/communication system can be found in ‘The GSM System for Mobile Communications’ by Michel Mouly and Marie Bernadette Pautet, Bay Foreign Language Books, 1992, ISBN 2950719007.

In the example of FIG. 1, a first remote station 101 and a second remote station 103 are in a first cell supported by a first base station 105. A remote station may e.g. be a User Equipment (UE) or a mobile station.

The first base station 105 is coupled to a first Base Station Controller (BSC) 107. A BSC performs many of the control functions related to the air interface including radio resource management and routing of data to and from appropriate base stations.

The first BSC 107 is coupled to a core network 109. A core network interconnects BSCs and is operable to route data between any two BSCs, thereby enabling a remote station in a cell to communicate with a remote station in any other cell. In addition, a core network comprises gateway functions for interconnecting to external networks such as the Public Switched Telephone Network (PSTN), thereby allowing remote stations to communicate with landline telephones and other communication terminals connected by a landline. Furthermore, the core network comprises much of the functionality required for managing a conventional cellular communication network including functionality for routing data, admission control, resource allocation, subscriber billing, remote station authentication etc.

The core network 109 is further coupled to a second BSC 111 which is coupled to a second base station 113. The second base station 113 supports a third remote station 115.

In order to establish links between the remote stations 101, 103, 115 (or an external network), the core network 109 comprises one or more switches that is capable of establishing links between a number of input connections and output connections. In the specific example, the core network 109 comprises a switch 117 to which the BSCs 107, 111 are coupled (it will be appreciated that although FIG. 1 illustrates only two BSCs, the switch may interconnect a significantly larger number of BSCs).

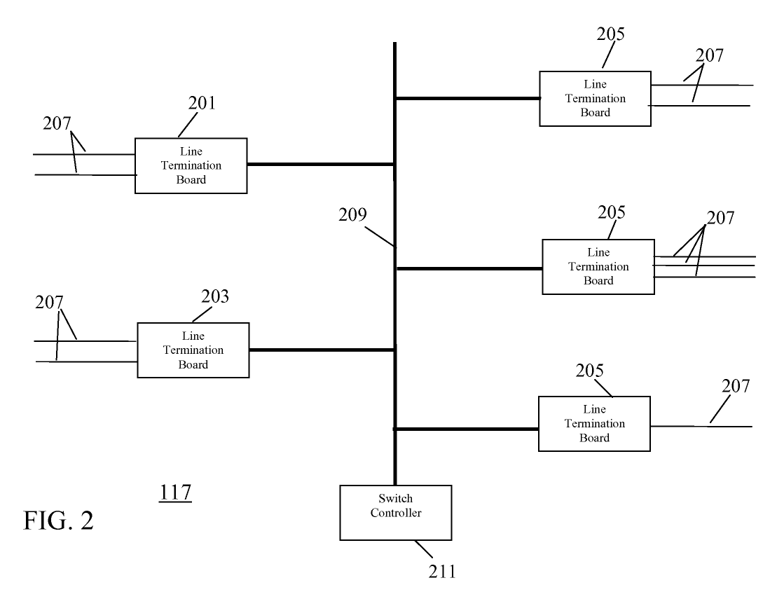

FIG. 2 illustrates an example of a switch 117 in accordance with some embodiments of the invention.

The switch 117 comprises a number of line termination boards 201, 203, 205. Each of the line termination boards 201, 203, 205 receives one or more E1 lines 207 from BSCs of the system. Specifically, a first line termination board 201 is coupled to the first BSC 107 by an E1 line and a second line termination board 203 is coupled to the second BSC 111 by another E1 line. Each of the E1 lines thus support a large number of connections corresponding to the active remote stations served by the associated BSC.

Thus, the line termination boards 201-205 receive and transmit call data to and from the individual BSCs 107,111. The E1 lines use a time division multiplexing system wherein time frames are divided into a number of time slots with individual time slots being allocated to individual remote stations 101, 103, 115. Specifically, each time slot can accommodate a pulse code modulated speech sample for a given voice call. For an E1 line of a GSM cellular communication system, each time slot is typically 125 μs. Thus, in the example, the connections supported by the E1 line correspond to time slots.

The line termination boards 201-205 are coupled together via a network 209. In the specific example, the network 209 is an Ethernet network but it will be appreciated that in other embodiments other interconnecting fabrics may be used and that the network may for example utilise a star or mesh configuration.

In the switch 117 of FIG. 1, the line termination boards 201-205 can communicate with each other and specifically data can be transmitted from any line termination board 201-205 to any other line termination board 201-205 by transmitting data packets on the Ethernet network 209.

The switch 117 furthermore comprises a switch controller 211 which is coupled to the Ethernet network 209. The switch controller 211 receives connection information which determines which of the input connections should be switched to which output connections. For example, the switch controller 211 can receive information which indicates that a circuit switched setup of a call between the first remote station 101 and the third remote station 115. Accordingly the switch controller 211 determines that a time slot of the E1 line from the first BSC 107 of the first line termination board 201 should be switched to the time slot assigned to the third remote station 115 on the E1 line from the second BSC 111 to the second line termination board 203.

In operation, the switch controller 211 communicates information to the line termination boards 201-205 that informs these of the destination for the data of the input E1 lines. For example, the first line termination board 201 is informed that the data of the time slot of the first remote station 101 should be sent to the second line termination board 203.

In operation, the switch 117 of FIG. 2 utilises switch intervals, henceforth referred to as Epochs. The Epoch is typically chosen to have a duration which is substantially longer then the switching interval of traditional switches.

Within each Epoch, each of the line termination boards 201-205 combine all the data which is to be transmitted to another of the line termination boards 201-205. Thus in each Epoch, the first line termination board 201 selects all the data from the incoming E1 lines which are to be forwarded to E1 lines of the second line termination board 203. This data is combined into a block of data which is then transmitted to the second line termination board 203. Similarly, within each Epoch the first line termination board 201 selects the incoming data for each of the other line termination boards 205 and transmits this data to the appropriate line termination board 205. Thus, within each Epoch the data is divided into data blocks for the different line termination boards and each data block is transmitted over the Ethernet network 209 to the appropriate destination line termination board.

In addition, the line termination boards 201-205 generate mapping data which is indicative of the destination of the data for each line termination board. Specifically, the first line termination board 201 generates mapping data for the second line termination board 203. This mapping data indicates which specific time slots on which specific E1 lines the individual data values should be allocated to. This mapping data is also transmitted from the first line termination board 201 to the second line termination board 203 via the Ethernet network 209. Similarly, mapping data is generated for the other line termination boards 205 and transmitted to these.

In each Epoch, the line termination boards 201-205 thus receive a data block and mapping data from each of the other line termination boards 201-205. In response, the line termination board 201-205 proceeds to allocate the user data of the data block to the appropriate time slots on the appropriate E1 lines 207. This allocation is performed in response to the mapping data which is received from the originating line termination board 201-205.

It will be appreciated that in the specific described embodiments the mapping data generation is performed at the individual line termination boards 201-205 but that in other embodiments the mapping data may be generated elsewhere than in the switch 117 such as for example in the switch controller.

The switch 117 provides a number of advantages over conventional switching technologies. For example, standardised and general purpose hardware and software, such as Ethernet hardware and software, can be used thereby reducing cost substantially. In particular, efficient switch performance can be achieved without the requirement for a real time switch matrix to be implemented.

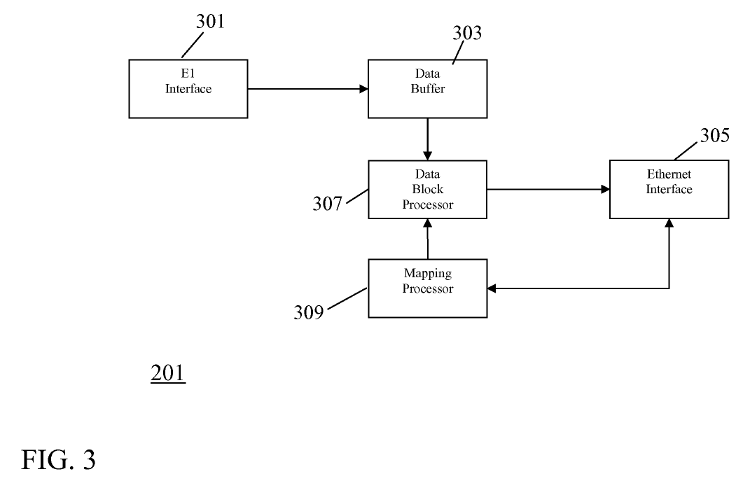

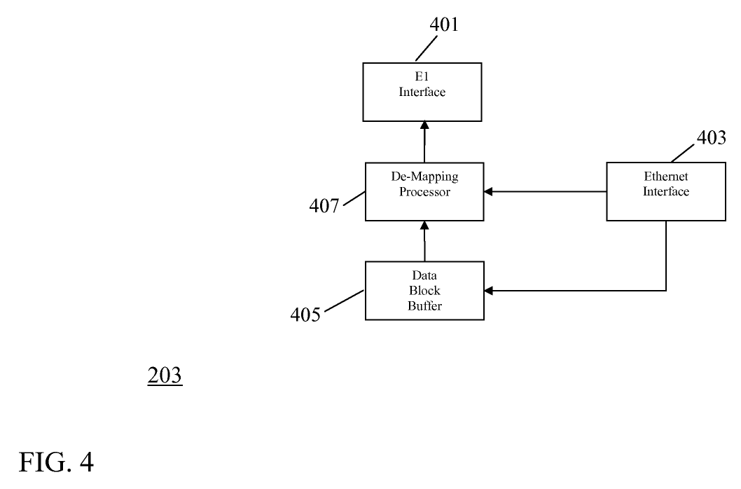

FIG. 3 illustrates some elements of the first line termination board 201 in accordance with some embodiments of the invention. FIG. 4 illustrates some elements of the second line termination board 203 in accordance with some embodiments of the invention. In the following, the operation of the switch 117 will be described with specific reference to switching of data from an input line of the first line termination board 201 to an output line of the second line termination board 203. Accordingly, input switch functionality of the first line termination board 201 and output switch functionality of the second line termination board 203 will be described. However, it will be appreciated that the first line termination board 201 can comprise output switch functionality and that the second line termination board of 203 can comprise input switch functionality. Indeed, min any embodiments all the line termination boards 201-205 may be substantially identical and comprise substantially the same hardware and software.

The first line termination board 201 comprises an E1 interface 301 which interfaces to the E1 line from the first BSC 107. The E1 interface 301 is coupled to a data buffer 303 which can store all the data received within an Epoch.

The first line termination board 201 furthermore comprises an Ethernet interface 305 which is arranged interface to the Ethernet network 209 connecting the line termination boards 201-205. Specifically, the Ethernet interface 305 can transmit data messages over the Ethernet network 209 to the other line termination boards 201-205.

The data buffer 303 is coupled to a data block processor 307 which for each Epoch combines the data of the input time slots that is to be switched to an E1 line of the second line termination board 203. The data is combined into a data block, which in the example comprises only traffic data and does not comprise any switching data that is indicative of which output timeslots or E1 lines the data should be switched to. Indeed, the data block may consist only of the in-call data. The data block processor 307 is furthermore coupled to the Ethernet interface 305 which transmits the data block to the second line termination board 203 in one are more Ethernet messages.

It will be appreciated that the data block processor 307 may use any suitable algorithm for combining or ordering the data. In a simple example, the combined data may simply be ordered to start with all the appropriate data of a first E1 line, followed by all the appropriate data of a second E1 line etc. Within each E1 line group, the data may simply be arranged in the order of the time slots in which the data was received. In such an example, no additional overhead data is required and specific data can be identified simply by its position within this data block.

The first line termination board 201 furthermore comprises a mapping processor 309 which is coupled to the data block processor 307 and the Ethernet interface 305. The mapping processor 309 maps the data of the data block to output timeslots of the second line termination board 203. In an example where each input/output time slot comprises only a single data value, the mapping data may for example indicate that the first data value of the data block should be switched to time slot number five on the second E1 line of the second line termination board 203, the second data value should be switched to time slot number ten on the first E1 line, the third data value should be switched to time slot number 1 on the first E1 line etc.

The mapping data is fed from the mapping processor 309 to the Ethernet interface 305 which transmits it to the second line termination board 203 in one of more Ethernet messages.

It will be appreciated that the mapping processor 309 may use any suitable algorithm or approach to determine the mapping data. Specifically, the mapping data can be determined in response to connection information which defines which input connections/timeslots should be switched to which output connections/timeslots.

In the specific example, the connection information is received from the switch controller 211. For example, when a new connection is set up between two remote stations, the switch controller 211 receives information of the setup from the system and identifies the appropriate time slots, E1 lines and line termination boards involved in the call setup. For example, for a call setup between the first remote station 101 and the third remote station 115, the switch controller 211 may identify that call data from the first remote station 101 is received in time slot number 15 of E1 line 1 coupled to the first line termination board 201 and transmitted to the third remote station in time slot number three of E1 line 2 coupled to the second line termination board 203. Accordingly, it may send connection information to the first line termination board 201 informing it that E1 line 1, time slot number fifteen should be included in the data block sent to the second line termination board 203 where it should be allocated to time slot number three of E1 line 2.

When determining the mapping data for the second line termination board 203, the mapping processor 309 accordingly proceeds to determine the position of the data value of time slot number fifteen of E1 line 1 in the block of data. For this position, the mapping data corresponding to time slot number three of E1 line to is included in the mapping data.

The second line termination board 203 comprises an E1 interface 401 which interfaces to the E1 line from the second BSC 111. The second line termination board 203 furthermore comprises an Ethernet interface 403 which interfaces to the Ethernet network 209. The Ethernet interface 403 is coupled to a data block buffer 405 which is fed the data block when it is received from the first line termination board 201. The Ethernet interface 403 and the data block buffer 405 is furthermore coupled to a de-mapping processor 407 which allocates data of the data block to the output timeslots in response to the mapping data.

For example, the de-mapping processor 407 evaluates the mapping data and identifies that the data value in a specific position of the block of data should be included in time slot number three of E1 line 1. It accordingly proceeds to extract the relevant data value and to include this in the specific time slot.

The data of the data block may relate to more than one output connection. For example, the data of a second time slot of the first E1 line of the first line termination board 201 may need to be forwarded to a time slot of the second E1 line of the second line termination board 203. Accordingly, the mapping data may indicate that the data value at another location of the data block must be allocated to the identified time slot on the second E1 line of the second line termination board 203.

Thus, the switch 117 provides an efficient switching performance wherein data of any input connection can be switched to any other connection without requiring the use of the real-time connection switch matrix. It will be appreciated that improved performance can be achieved in many embodiments by having a switch interval that includes a larger number of input timeslots/connections. Specifically, the data buffer 303 may in many embodiments store more than ten input connections and in the specific example will store more than ten timeslots. Indeed in some embodiments, a significantly larger number of timeslots may be processed within each switch interval, such as for example a hundred or a thousand timeslots of each E1 line may be processed within each switch interval. This may allow improved trunking efficiency within the switch 117.

It will also be appreciated that a significant advantage of the described approach is that the mapping data and the in-call data may be communicated independently on the Ethernet network 209. This may for example allow the mapping data update to be independent of the switching interval. Specifically it may allow that the same mapping data is used for a plurality of switch intervals. For example, the required switching may only change when a new connection between remote stations is set up or terminated and the mapping data may be maintained constant between such events. Furthermore, in some embodiments only relative mapping data may be transmitted such as mapping data reflecting connection changes.

Specifically, switching updates do not have to be on a 125 us interval, but can be on an N×125 us interval as well up to, for example, five×125 us intervals. This may add a delay to call setup but this will generally be a negligible and deterministic delay.

Thus, in the system, signalling is decoupled from data transfer such that line termination board mapping, switch updating and data transferring are not directly dependent but can operate on different time scales providing a flexible architecture where, for instance, if a setup can wait for 50 ms at the expense of more connections being switched and more data being sent per unit time, then e.g. 100 ms switch update but 125 us data forward update can be implemented. That is, priority can be given to data switching as opposed to control processing. However, this does not preclude the inclusion of control information in data frames (control traffic could be time-synchronized with timeslot traffic and be sent using a common frame).

The described approach allows that data is packet routed over a fabric interconnect rather than a bus allowing facilitated packet signalling and data messaging. Furthermore, a common media is used for control and data (timeslots) traffic. In the system, switching control is performed in batches of line termination board to line termination board mappings of connections on a regular time interval (Epoch) rather than one connection at time, but can also be on a per connection basis if this preferred. Specifically, connection changes for a specific line termination board can be batched to form a connection request packet thereby reducing processing overhead.

Furthermore, the packet switch fabric approach can allow efficient scaling of the switch. For example, scaling from one fabric to multiple fabrics-size by providing the inter fabric connections that allow line termination boards from one fabric to set up connections to another line termination board on another fabric thereby providing extensibility for the switching and data planes.

The switch may furthermore be suitable for sub-rate switching. E.g. the mapping data can include a data rate indication for data for a given remote station and this can be used to allocate data to the individual output time slots. For example signalled line termination board mappings can describe the data block content of all connections carried in each data block between the line termination boards. Thus, no overhead is required to indicate e.g. 1, 2, 4, 8 bits of data per timeslot sent between line termination boards of the data block as this can be known by position and the indicated sub-rate in the mapping data.

The described architecture may furthermore allow a low complexity 1:N fan-out. For example, data from the first remote station 101 may be forwarded to a plurality of remote stations simply by including mapping data that maps the corresponding data of a data block to a plurality of output time slots/E1 lines. Furthermore, the input data can be included in data blocks for a plurality of line termination boards and the corresponding mapping data can be included in the mapping data for these line termination boards.

Also, the approach allows that only valid user data is forwarded to the destination. For example, due to discontinuous transmission techniques, such as DTX for GSM, some input time slots may not carry any data. In such a case, the data block processor 307 may not include data in the data block for these time slots. This may allow a massive saving on data routed at the switch fabric as data is only sent when there is anything to send on any of the connections at each frame interval at the interfaces.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a unit, in a plurality of units or as part of other functional units. As such, the invention may be implemented in a unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An apparatus for switching data between input and output lines, the apparatus comprising:
a plurality of input means each having at least one input line supporting a plurality of input connections;
a plurality of output means each having at least one output line supporting a plurality of output connections;
a network connecting the plurality of input means with the plurality of output means; wherein
at least a first input means comprises:
means for, for each switch interval, combining data of the input connections for a first output means into a data block, and
means for, for each switch interval, transmitting the data block to the first output means over the network;
and the apparatus further comprises:
mapping means for generating mapping data that maps data of the data block to output connections of at least one output line of the first output means; and
means for transmitting the mapping data to the first output means;
and wherein the first output means comprises allocation means for allocating data of the data block to the output connections in response to the mapping data.

2. The apparatus of claim 1 wherein the input connections correspond to time slots of the at least one input line and the output connections correspond to time slots of the at least one output line.

3. The apparatus of claim 1 wherein the data block comprises no signalling overhead data.

4. The apparatus of claim 1 wherein the mapping data associates user data of time slots of the input lines with time slots of the output lines.

5. The apparatus of claim 1 wherein the network is an Ethernet network.

6. The apparatus of claim 1 wherein the at least one input line is an E1 line.

7. The apparatus of claim 1 wherein the mapping data includes a data rate indication for data of an input connection.

8. The apparatus of claim 1 wherein the mapping means is arranged to update the mapping data with a different time interval than the switch interval.

9. The apparatus of claim 1 wherein the mapping means is arranged to determine the mapping data in response to a signalled connection request.

10. The apparatus of claim 1 wherein the mapping data associates positions of data in the data block to output connections.

11. The apparatus of claim 1 wherein the allocation means is arranged to allocate data of the data block to output connections of a plurality of output lines.

12. The apparatus of claim 1 wherein the mapping data comprises a mapping of a data block of an input connection to a plurality of output connections.

13. The apparatus of claim 1 wherein a number of input connections per switch interval is more than ten input connections per input means.

14. The apparatus of claim 1 wherein the means for combining data of the input connections is arranged not to include data in the data block for input connections not comprising data.

15. The apparatus of claim 1 wherein the mapping means comprises:
means for receiving connection information associating input connections and output connections; and
means for determining the mapping data in response to the connection information.

16. The apparatus of claim 1 wherein the mapping data relates to a plurality of input lines.

17. The apparatus of claim 1 wherein the mapping data relates to a plurality of output lines.

18. A method of switching data between input and output lines in an apparatus having a plurality of input means each having at least one input line supporting a plurality of input connections; a plurality of output means each having at least one output line supporting a plurality of output connections and a network connecting the plurality of input means with the plurality of output means; the method comprising:
at a first input means performing the steps of:
for each switch interval, combining data of the input connections for a first output means into a data block; and
for each switch interval, transmitting the data block to the first output means over the network; and
further performing the steps of:
generating mapping data that maps data of the data block to output connections of at least one output line of the first output means; and
transmitting the mapping data to the first output means;
and at the output means allocating data of the data block to the output connections in response to the mapping data.
